(19) United States
(12) Patent Application Publication
(10) Pub. No.: US 2018/0025200 A1
(43) Pub. Date: Jan. 25, 2018

(54) LUMINESCENT FILM WITH QUANTUM DOTS

(71) Applicant: IB Korea Ltd., Gyeonggi-do (KR)

(72) Inventors: Frederick Frye, Simpsonville, SC (US); Douglas Loy, Gilbert, AZ (US)

(21) Appl. No.: 15/654,951

(22) Filed: Jul. 20, 2017

Related U.S. Application Data
(60) Provisional application No. 62/364,505, filed on Jul. 20, 2016.

(51) Int. Cl. G06K 9/00; G06F 21/32; G06F 3/041

(52) U.S. Cl. CPC G06K 9/0004; G06F 3/0412; G06F 21/32; B41M 3/00

(57) ABSTRACT

One or more techniques and/or systems are disclosed for a luminescent film that can be used with a biometric imager, which can be used to scan biometric markers, and/or to interact with the device. Upon contacting a device surface, an image of at least a portion of the touch object can be captured and used in conjunction with identification of the user and/or for input to the device. The systems or techniques, described herein, may be integrated into a portion of a device, and may comprise a luminescent layer, comprising quantum dots, that can emit photons upon contact, and an image capture component that can generate data indicative of an image of at least a portion of the touch object.

### CROSS-REFERENCE TO RELATED APPLICATIONS

This application claims priority to U.S. Provisional Application Ser. No. 62/364,505 entitled ELECTROLUMINESCENT FILM WITH QUANTUM DOTS, filed Jul. 20, 2016, which is incorporated herein by reference.

### BACKGROUND

A contact light emitting device can comprise a film that may be used for relief object imaging. Such a device can be constructed with a luminescent layer and a transparent electrode layer such that an electric field is generated between a transparent electrode layer and the object to be imaged. When the object is brought adjacent the device, an electric field may be developed between the object and the transparent electrode causing the luminescent layer to emit light (e.g., electroluminescent or EL) that is indicative of the relief of the object. Electroluminescent (EL) films typically utilize inorganic phosphors, such as zinc sulphide, with a dopant activator and coactivator, such as copper and chlorine (ZnS:Cu:Cl). The phosphors can suffer from a limited, useful lifetime and low efficiency. Often, due to the low efficiency, the use of high voltages and frequencies is utilized, which can exacerbate their useful lifetime, and may also lead to deleterious effects in other layers/materials and in other components/processes in which the electroluminescent film is used.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

As provided herein, alternative emitters and device configurations for alternating current (AC) driven electroluminescent (EL) devices for imaging. Organic emitters (e.g., organic phosphors and fluorophores) can provide very high efficiencies, but are traditionally operated using direct current (DC). However, some of these organic emitters have a demonstrated ability to achieve high efficiencies when driven with AC voltage. Additionally, systems and methods, described herein, can utilize quantum dots (QDs) in conjunction with the organic emitters/conductors, which can also improve efficiencies. As an example, such materials can be used to create EL devices for use in relief object images, such as fingerprint reading devices. Use of QDs in conjunction with certain organic emitter/conductors can improve brightness and efficiency, which may also reduce power used to capture an image. For example, lowering of power requirements may allow the fingerprint device to be used in a more ubiquitous fashion, such as for large area imaging.

In one implementation, a biometric sensor system can comprise a luminescent layer. In this implementation, the luminescent layer can comprise quantum dots that are configured to provide luminescence. Further, the luminescent layer can be configured to emit photons upon contact from a biometric object. The biometric sensor system can comprise an image capture component that is disposed beneath the luminescent layer. The image capture component can be configured to convert at least a portion of the photons emitted into data that is indicative of an image comprising a representation of at least a portion of the biometric object.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIG. 1 is a component diagram illustrating an exemplary input device.

FIGS. 2A and 2B are component diagrams illustrating example implementations of one or more portions of one or more systems described herein.

FIGS. 3A and 3B are component diagrams illustrating example implementations of one or more portions of one or more systems described herein.

FIG. 4 is a component diagram illustrating an example implementation of at least a portion of a one or more systems described herein.

FIG. 5 is a component diagram illustrating an example implementation of at least a portion of a one or more systems described herein.

FIG. 6 is a component diagram illustrating an example implementation of at least a portion of a one or more systems described herein.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices may be shown in block diagram form in order to facilitate describing the claimed subject matter.

Quantum dots (QDs) are small particles or nanocrystals of a semiconducting material comprising diameters in the range of 2-10 nanometers. The electronic properties of QDs are somewhere between those of a bulk semiconductor material and a single molecule, which may be a result of a high surface-to-volume ratio of the QDs. The electrical properties can include fluorescence of the particle when subjected to an electric field, which may be used in one or more implementations of one or more systems and techniques described herein. The color of the fluorescence may be a result of, and correlated to, the size and/or molecular makeup of the quantum dot. Generally, as the size of the particle decreases, the difference in energy between a highest valence band and a lowest conduction band increases in the particle. Therefore, for example, the QD may exhibit an inversely proportional relationship between particle size and energy difference between high valence band and low conduction band of electrons. As a result of the increase in band energy in smaller QDs, more energy may be needed to excite the particle, resulting in more energy being released. The luminescent properties of QDs occur due to the recombination of an electron-hole pair (a.k.a. exciton decay) through radiative pathways. When the QD material returns to its ground state it emits photons. QDs can emit a variety of colors of light using the same material, for example, by changing the size of the particle. Further, the QD can emit a variety of colors of light using different materials, and also by changing the size of the particle.

In one aspect, QDs can be made by a variety of techniques. QD manufacture methods can include, but are not limited to, molecular beam epitaxy (MBE), which utilizes beams of atoms are fired at a substrate to create a single crystal; ion implantation, which utilizes electrically accelerated ions fired at a substrate; X-ray lithography, which utilizes X-rays to build or engrave atoms from a substrate; and colloidal synthesis, where crystals can be formed using solutions.

There are several types of QDs, including, but not limited to, core-type quantum dots, core-shell quantum dots, and alloyed quantum dots. A core-type quantum dot may be comprised of a single component material (e.g., same molecular material), having a substantially uniform internal composition, such as composed of chalcogenides of metals like cadmium or zinc, such as sulfides, selenides, and tellurides. These types of QDs can be tuned (e.g., to different energy levels and/or different colors) by changing the particle size, resulting in different luminescent properties, such as colors and intensities.

A core-shell quantum dot may be made by growing one or more shells of a higher band gap semiconducting material around a core-type QD comprising a lower band gap material. Coating a quantum dot with shell can improve quantum yield, and therefore efficiency and brightness output, by improving passivizing of nonradiative recombination sites that involve transformation of the electronic excitation energy into other types of energy than light. This type of coating can also be used to tune the photo/electro luminescent properties of the QD.

An alloyed quantum dot is a multicomponent material. Alloyed quantum dots can be used to tune the luminescent properties without changing the size of the particle, and can be made up of homogeneous or gradient internal structures. Changing the composition and/or internal structure can change the luminescent properties. Alloyed semiconductor quantum dots are formed by alloying together two different semiconductors with different band gap energies. The resulting alloyed QDs typically display different and distinct properties from the parent semiconductors, as well as their bulk counterparts.

As provided herein, a system or one or more techniques may be devised for a luminescent film that can be utilized on a biometric imaging device, and/or a touch enabled computing device and/or information appliance. As an example, photons emitted from a luminescent layer comprising quantum dots can be detected by an associated image sensor and converted to corresponding electrical signals. In this example, the electrical signals may be indicative of one or more biometric markers from an applied biometric object (e.g., by finger) to the surface of the system. Further, the signals may be processed to produce an image representing the one or more biometric markers of the biometric object. In one aspect, the systems or techniques, described herein, may be integrated into a standalone biometric reader for enrollment, detection, and/or security purposes. In another implementation, the systems or techniques, described herein, may be integrated into the surface of a touch-enabled device and used to associate a user of the device with desired data (e.g., for security purposes, enrollment, or other identification purposes). In another aspect, the signals/data produced by the image sensor component may be used to provide input to the device and/or interact with the touch-enabled device.

In one aspect, the use of quantum dots in the light emitting layer, or the luminescent layer may improve the outcome of a biometric scan. That is for example, the use of quantum dots can greatly improve the resolution of an image generated by a biometric scan. In this example, quantum dots can provide for increased brightness, and may be fine-tuned to provide a desired color output. Additionally, by using quantum dots, a lower electrical charge can be used to provide a resulting image that meets or exceeds image characteristics used for biometric imaging (e.g., enrollment, detection, etc.). In this way, for example, biometric scanners may be smaller, and/or may have lower power usage needs in order to provide the desired results.

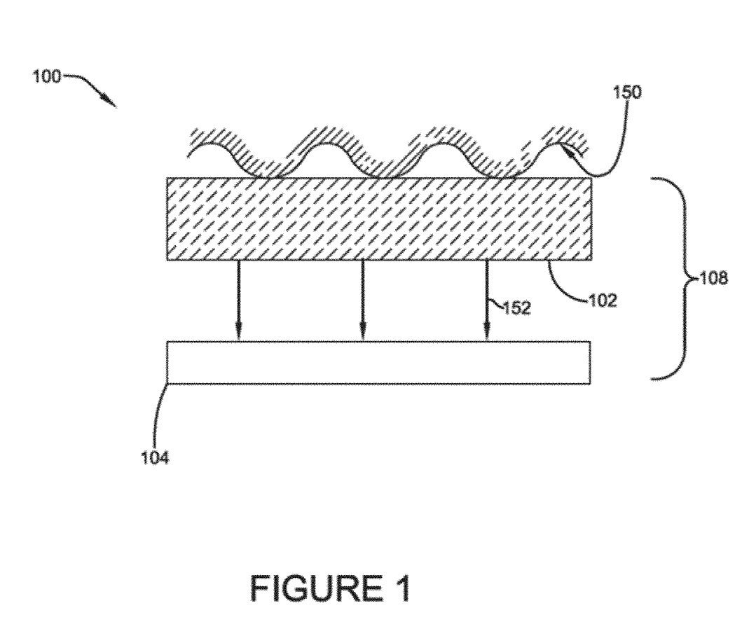

FIG. 1 is a component diagram illustrating an exemplary biometric marker imaging device 100. The exemplary biometric imaging device 100 can comprise a luminescent layer 102 (e.g., comprising quantum dots) that is configured to emit one or more photons 152 in a first direction from a portion of the luminescent layer 102 that receives contact from a biometric object 150. The luminescent layer 102 can comprise quantum dots, as described above. As one example, a user may touch the surface of the luminescent layer 102 with their finger 150. In this example, the luminescent layer 102 may emit photons 152 merely at the location of the touch contact (e.g., from the ridges of a fingerprint).

In one implementation, the luminescent layer 102 may comprise an electroluminescent material that can convert an electrical charge into photons 152, including, but not limited to, quantum dots. In this implementation, for example, a natural electrical potential difference of a human (e.g., provided by membrane potential) can provide between 10 and 80 volts (e.g., root mean square (RMS) voltage) of electrical charge to the luminescent layer 102. Further, in this implementation, the electrical charge provided to the luminescent layer 102 can be converted into photons 152 by the electroluminescent material disposed in the luminescent layer 102, for example.

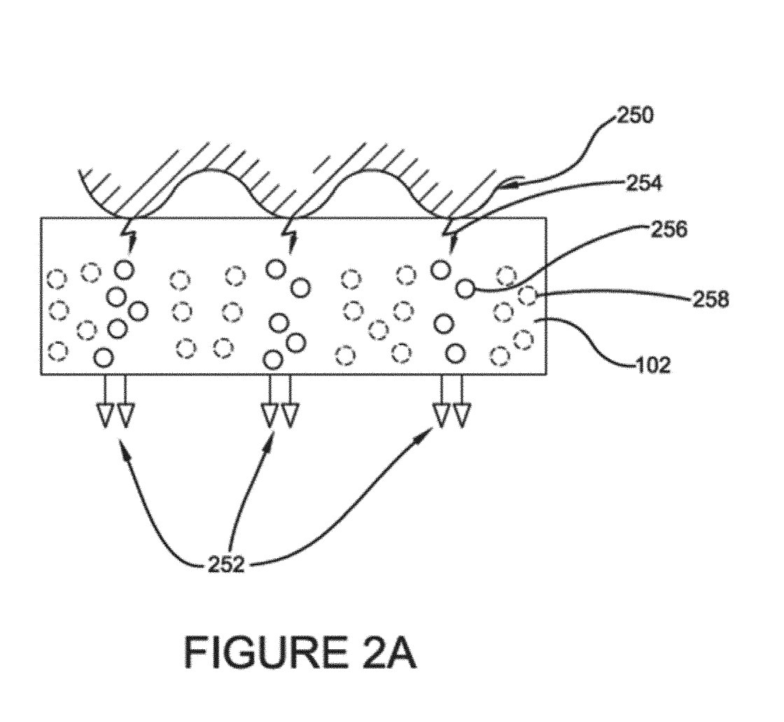

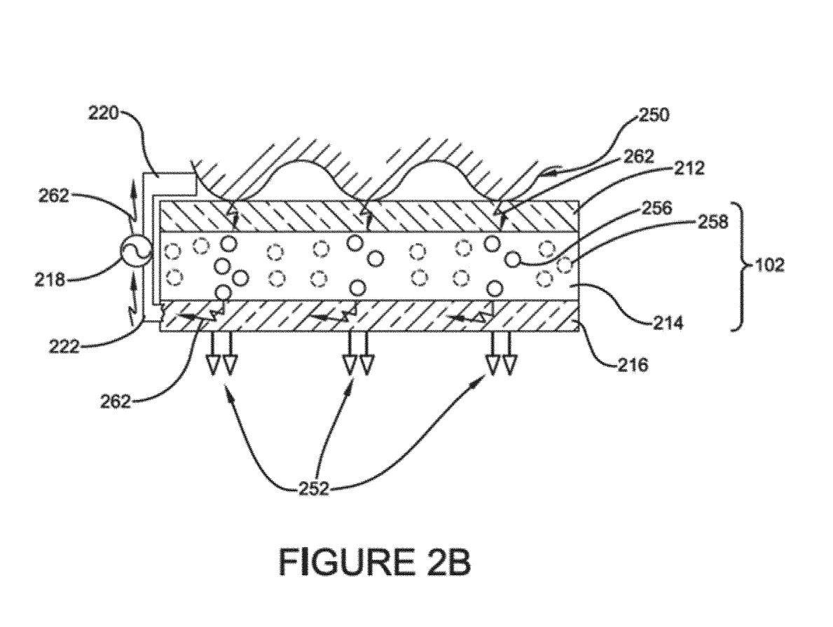

As an illustrative example, FIG. 2A is a component diagram illustrating an example implementation of one or more portions of one or more systems described herein. In one implementation, the luminescent layer 102 can comprise electroluminescent materials 258 (e.g., quantum dots and fluorescent particles, such as phosphor-based materials, such as phosphor-based inorganic crystal materials with a transitional metal as a dopant or activator, zinc sulfide-based materials, cadmium sulfide-based materials, gallium-based materials, other semi-conductor materials, etc.) and a binder material. In one implementation, when a biometric object 250 (e.g., finger or other body part) contacts the luminescent layer 102 and provides the electrical charge 254, the electroluminescent materials 258 may be converted to “activated” particles 256, when subjected to the electrical charge 254, merely at the location of the touch. Further, in this implementation, the “activated” particles 256 may emit photons 252, for example, thereby producing light when subjected to the electrical charge 254.

As an example, the natural electrical potential difference of a human (e.g., provided by membrane potential) can provide between 10 and 200 volts of electrical charge 254 to the contact surface (e.g., top layer) of the luminescent layer 102. Further, in this implementation, when the biometric object 250 contacts the contact surface of the luminescent layer 102, the electrical charge 254 can be provided to the luminescent layer 102. The electrical charge 254 can be converted into photons 252 by activating the luminescent particles 258, thereby becoming “activated” luminescent particles 256 and yielding photons 252, such as toward an image sensing component (e.g., 104). Further, in the addition of quantum dots may provide improved luminescence and/or image clarity for the resulting image data.

As an example, when electroluminescent particles are subjected to an electric charge, spontaneous emission of a photon, due to radiative recombination of electrons and holes, can occur. This process can result when a light source, such as a quantum dot or fluorescent molecule in an excited state (e.g., subjected to an electric charge), undergoes a transition to a lower energy state and emits a photon. In this example, when these materials are in an excited state they can undergo the transition to a lower energy state and emit a photon. Further, as an example, quantum dots of different materials and/or different sizes may be utilized in the electroluminescent particles. In this example, a smaller QD may emit a different color and intensity of light than a larger QD; and/or a QD of multiple materials (e.g., core-shell or alloyed) may also emit different colors and intensities depending on the type and amount of each material comprised in the QD.

Returning to FIG. 1, the exemplary biometric imager device 100 can comprise an image capture component 104. The image capture component 104 can be operably engaged with the luminescent layer 102, such that the image capture component 104 is disposed in a path of the direction of the emitted photons 152. Further, the image capture component 104 may be configured to convert the received photons 152 to an electrical signal. That is, for example, the image capture component 104 may comprise photosensitive material that results in an electrical signal being produced when one or more photons 152 impact the material. In this way, for example, a location and/or number of photons impacting the image capture component 104 may be indicated by a number (e.g., or power) of electrical signals, from an area of the image capture component 104 subjected to the photon 152 impacts. In one implementation, the resulting electrical signals may comprise data indicative of a representation (e.g., image) of the contact area(s) of the biometric object.

In one implementation, the image capture component 104 may comprise an active pixel sensor (APS) or passive pixel sensor (PPS), such as a thin film sensor (e.g., photo-sensitive thin film transistor (TFT), thin film photo-diode, photo-conductor) or complementary metal-oxide semiconductor (CMOS). As another example, the sensor arrangement 104 may comprise a charge-coupled device (CCD), a contact image sensor (CIS), or some other light sensor that can convert photons into an electrical signal. Of note, the illustration of FIG. 1 is merely an exemplary implementation of the biometric imager device 100 and is not intended to provide any limitations. That is, for example, the gap illustrated between the luminescent layer 102 and the image capture component 104 is exaggerated for purposes of explanation, and may or may not be present in the exemplary biometric imager device 100.

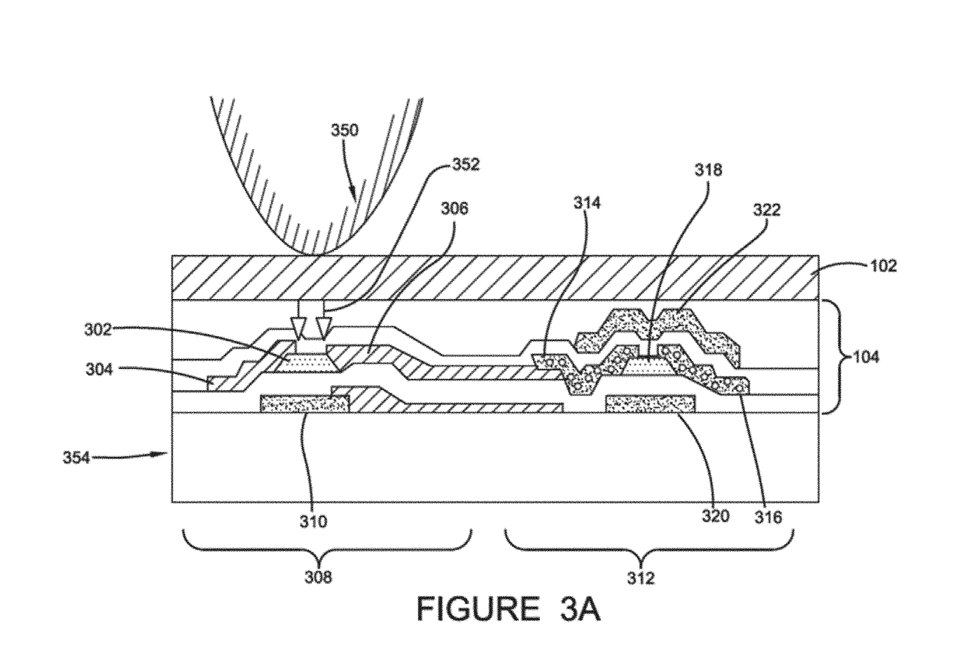

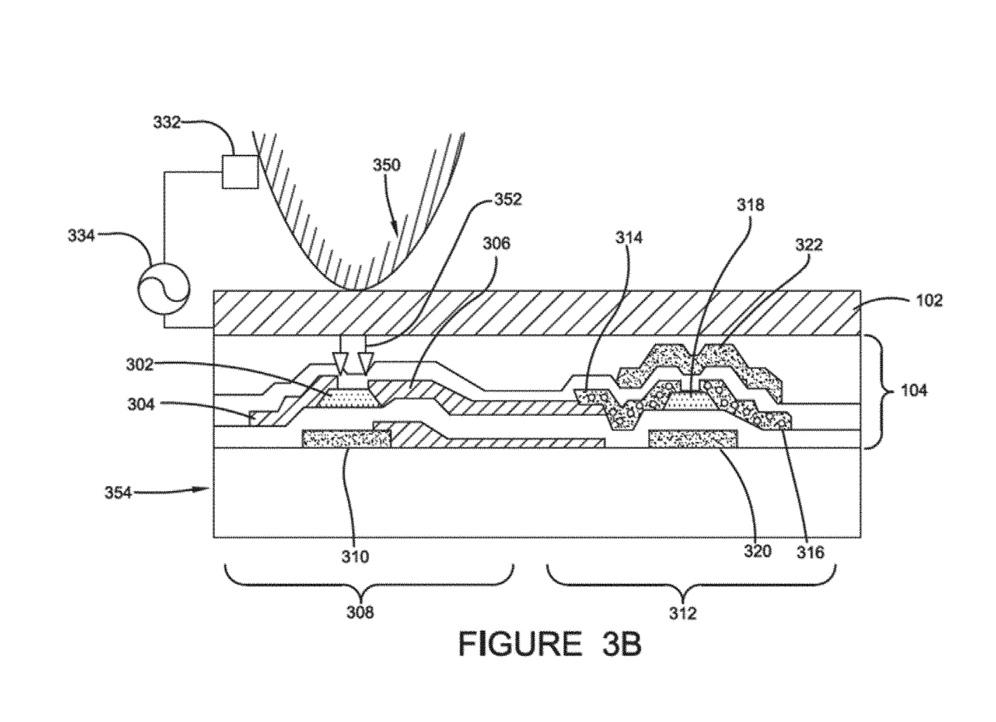

As an illustrative example, FIG. 3A is a component diagram illustrating an example implementation of one or more portions of one or more systems described herein. In the example implementation of FIG. 3A, the luminescent layer 102 may be disposed over the image capture component 104, which can be used to convert incoming photons 352 into an electronic signal. In one implementation, the image capture component 104 may comprise a thin film sensor array. For example, a thin film sensor-array may be used to detect photons 352 emitted by the luminescent layer 102. Here, as an example, the image capture component 104 can detect photons 352 produced by the luminescent layer 102 (e.g., produced as a result of the biometric object contacting the surface of the luminescent layer 102, where the luminescent layer comprise QDs that emit the photons) and convert the detected photons 352 into an electrical signal.

In this example implementation, a photo-sensitive material 302 (e.g., comprising a semiconductor material, such as SiH, amorphous silicon, germanium-based materials, indium gallium-based materials, lead-based materials, and organic photo sensitive material, such as organic photoconductors and photodiodes) may be formed between a first source electrode 304 and a first drain electrode 306 of a light sensing unit 308. When an electrical charge is applied to a first gate electrode 310, the photo-sensitive layer 302 can become responsive to light, for example, where the photo-sensitive layer 302 may become electrically conductive when incident to photons of light. As one example, when light is incident on the photo-sensitive layer 302 over a predetermined, threshold light amount, the first source electrode 304 and the first drain electrode 306 may become electrically connected. Therefore, in this example, light generated from the luminescent layer 102 (e.g., comprising a fingerprint pattern indicated by the fingerprint ridges) may be received by the photo-sensitive layer 302, which may cause an electrical signal to pass from the first source electrode 304 to the first drain electrode 306 (e.g., providing an electronic signal indicative of the light received).

Further, in one implementation, a switching unit 312 of the image capture component 104 can comprise a second source electrode 314, a second drain electrode 316 and an intrinsic semiconductor layer 318. As one example, when a negative charge is applied to a second gate electrode 320, the intrinsic semiconductor layer 318 may become electrically conductive, thereby allowing the electrical signal created at the light sensing unit 308 to pass from the second source electrode to the second drain electrode (e.g., and to an electrical signal reading component for converting to a digital image). In this way, for example, the switching unit 312 may be used to control when an electrical signal indicative of a particular amount of light may be sent to an electrical signal reading component (e.g., for processing purposes, signal location purposes, and/or to mitigate signal interference with neighboring light sensing units).

Additionally, in one implementation, a light shielding layer 322 may be resident over the top portion of the switching unit 312. As one example, the light shielding layer 322 may mitigate intrusion of light to the intrinsic semiconductor layer 318, as light can affect the electrical conductivity of the intrinsic semiconductor layer 318. The image capture component 104 may also comprise a substrate 354 of any suitable material, onto which the layers of the image capture component 104 may be formed. As one example, when a biometric object 350 (e.g., finger, etc.) comes into contact with a contact surface (e.g., top surface, top coating, protective layer) of the luminescent layer 102, an electrical charge may pass into the luminescent layer 102. In this example, the luminescent layer 102 may emit photons 352 that are incident to the photo-sensitive layer 302, thereby allowing an electrical signal (e.g., indicative of the number of photons received, and/or location of the received photons) to pass from the first source electrode 304 to the second drain electrode 316.

In one aspect, the exemplary biometric imager device 100 may be used to generate a biometric object relief print. As one example, the exemplary biometric imager device 100 may be used to capture a fingerprint of one or more of a user's fingers (e.g., or other biometric object) placed on the surface of the luminescent layer 102, such as for security purposes, user identification, biometric data logging, biometric data comparison and retrieval, etc. In one implementation, in this aspect, in order to generate an appropriate biometric object relief print (e.g., fingerprint), greater definition of finer details of the biometric object may be needed (e.g., greater than for a touch location detection). In this implementation, a supplemental electrical charge may be used to increase a number of photons produced by the luminescent layer 102, for example, where the increase in photons may provide improved detail definition and improved contrast for finer detail in a resulting image.

As an illustrative example, FIG. 2B is a component diagram illustrating an example implementation of one or more portions of one or more systems described herein. In the example implementation of FIG. 2B, the luminescent layer 102 may comprise an electrode-based (e.g., single electrode), electroluminescence component. Further, in this implementation, the luminescent layer 102 can comprise an electricity supply 218 (e.g., a power source, such as an AC source), which may provide an electrical connection between the biometric object 250 and the luminescent layer 102. Further, in one implementation, the luminescent layer 102 may comprise a transparent electrode layer 216 (e.g., comprising an indium tin oxide (ITO) material) (e.g., or another optically transparent conductor), an electroluminescent layer 214, and/or a dielectric layer 212 (e.g., a conductive/insulating layer that allows electric potential or an electric field to build across the luminescent layer 102). In this implementation, for example, when the exemplary biometric imager device 100 is activated (e.g., by placing a finger on the surface of the device), photons 252 produced by the luminescent layer 102 can be emitted in the first direction, such as directed toward the image capture component 104.

In FIG. 2B, the luminescent element 102 can comprise the electroluminescent layer 214, for example, comprised of electroluminescent material 258 (e.g., comprising QDs) and a binder material. In one implementation, the electroluminescent material 258 may comprise “activated” particles 256, such as when subjected to an electrical field 262. Further, in this implementation, the “activated” particles 256 may emit photons 252, for example, thereby producing light when subjected to the electrical current 262. Further, in this example implementation, the dielectric layer 212 is resident over the top portion of, and in contact with, the electroluminescent layer 214; and the transparent electrode 216 (e.g., a receiving electrode) is resident under the bottom portion of, and in contact with, the electroluminescent layer 214. Further, the power source 218, such as an alternating current (AC) power source, may be electrically coupled with an electrode connection 222, in electrical connection with the transparent electrode 216, and a contact electrode 220 (e.g., a biometric object contact electrode) residing substantially adjacent to, a contact surface (e.g., top surface) of the dielectric layer 212.

In one implementation, the biometric object 250 may contact both the contact surface of the dielectric layer 212 and the contact electrode 220. In this implementation, for example, upon contacting both the dielectric layer 212 and the object contact electrode 220, an electrical circuit may be created between the contact electrode 220 and the transparent electrode 216, thereby allowing voltage potential 262 to flow between the two electrodes. Further, in this implementation, those portions of the biometric object 250 (e.g., body-part relief ridges) that come in contact with the contact surface of the dielectric material layer 212 can allow a voltage potential across the contact electrode 220 and transparent electrode 216. Additionally, the electric field 262 can “activate” the electroluminescent particles 256 merely at the location of the touch. Upon “activation,” the activated particles 256 may emit photons 252 merely at the location of the contact of the portions of the biometric object 250 (e.g., fingerprint ridges). In this way, for example, an illuminated relief print (e.g., fingerprint) of the biometric object 250 (e.g., finger) may be produced when the biometric object 250 contacts both the contact electrode 220 and the contact surface of the dielectric layer 212.

As another illustrative example, FIG. 3B is a component diagram illustrating an example implementation of one or more portions of one or more systems described herein. In this example implementation, the luminescent layer 102 is coupled with the example, image capture component 104 (e.g., such as an image generation component), which is disposed on an example, substrate layer 354. Further, in this implementation of a portion of the exemplary device 100, the luminescent layer 102 is electrically coupled with a power source 334, which is electrically coupled with a grounding electrode 332. In this implementation, as an example, when a biometric object (e.g., finger, etc.) comes into contact with the grounding electrode 332 and the luminescent layer 102 (e.g., the dielectric layer 212 of FIG. 2B), an electrical current is passed from the power source 334 to the grounding electrode 332, and into the luminescent layer 102 through the biometric object 350. The resulting photons 352 emitted by the luminescent layer 102 (e.g., by the QDs in the electroluminescent layer 214 of FIG. 2B) may impact on the photo-sensitive layer 302 of the image capture component 104, resulting in the output of one or more electrical signals, indicative of a relief print of the biometric object 350 (e.g., at least the ridges of the fingerprint of the finger).

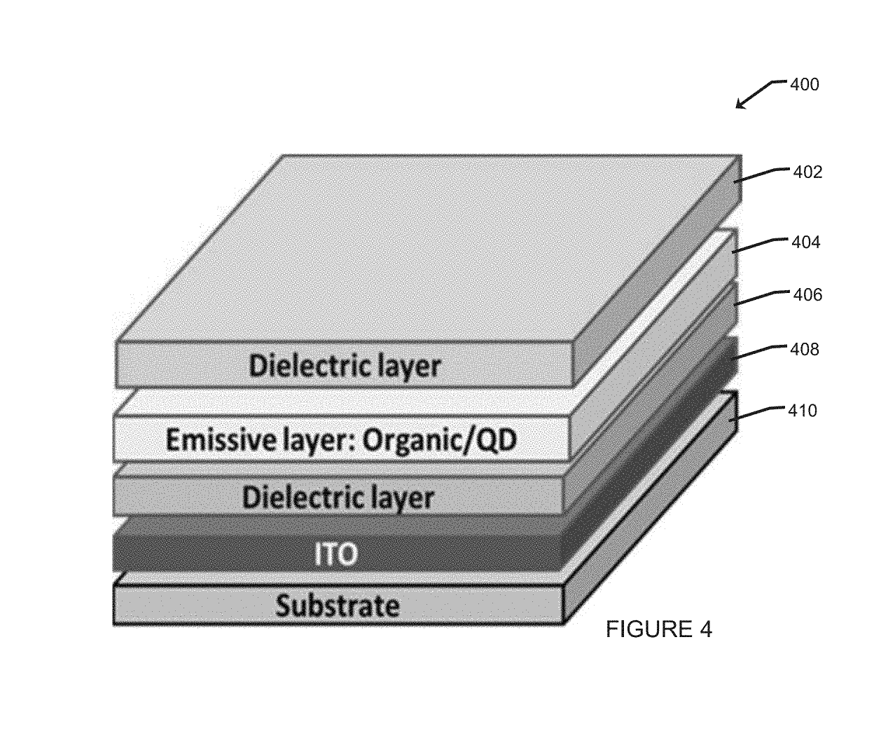

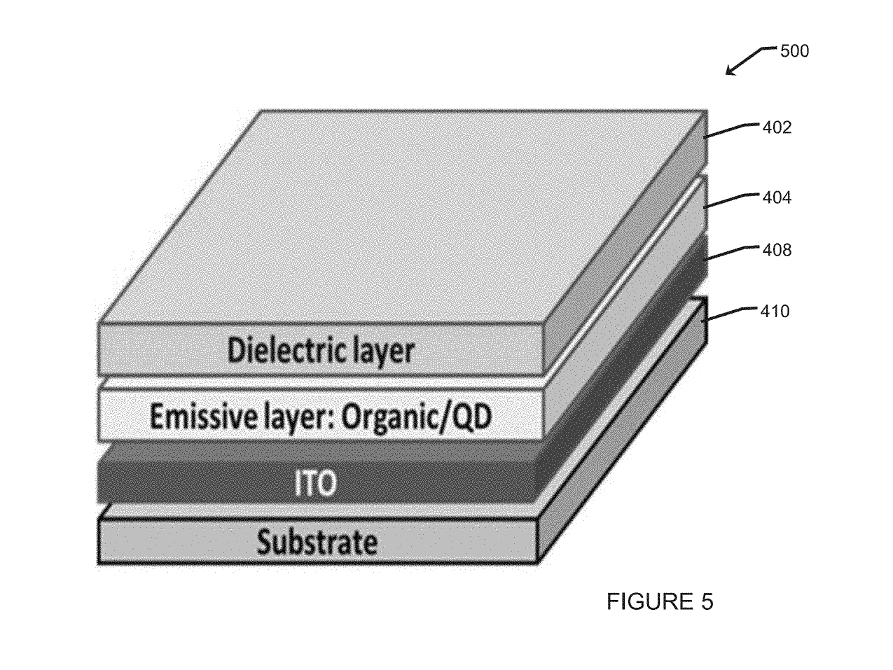

FIGS. 4 and 5 are component diagrams illustrating various implementations of luminescent film or luminescent layer 400, 500 that may be used in an image sensing device, such as relief print image generation device. In one aspect, a luminescent film (e.g., 400, 500) comprising quantum dots, for use in an image capture device, may be constructed with varying layers. In one implementation, such as 400 in FIG. 4, a conductive substrate 410 may be formed with (e.g., under) a transparent electrode 408, such as Indium Tin Oxide (ITO) on Polyethylene terephthalate (PET), or glass coated with a polarizing dielectric, and/or a transparent electrode. Further, in this implementation, a first dielectric layer 406 may be formed or disposed over the combined substrate 410 and transparent electrode or conductive layer 408. Additionally, in this implementation, the substrate 410, transparent electrode 408 and dielectric layer 406 may be covered by a light emitting layer 404 (e.g., comprising organic emitters and/or a quantum dots compound), which may be then covered by a second dielectric or protective layer 402.

In one implementation, in this aspect, the light emissive layer (e.g., 404) can be comprised of small molecule emitters or polymeric emitters, or a combination thereof. As an example, small molecule emitters, such as those used in a typical organic light-emitting diode (OLED) device, such as Ir(ppy)3 and its analogs, may be used. In this example, when a small molecule emitter is utilized in the layer (e.g., film) a host or binder material may be needed to produce the film. As another example, polymeric emitters such as Poly-(N-vinyl carbazole) (PVK), polyflourines (PFO) and Poly(9,9-dioctylfluorene-alt-benzothiadiazole) (F8BT) and others used in typical polymeric OLED devices may be utilized. In one implementation, quantum dots can be included in the light emissive layer 404, and may be comprised of a variety of materials. For example quantum dots may comprise: cadmium, zinc, indium, silicon, germanium; compounds such as cadmium sulfide (CdS) or cadmium selenide (CdSe); and other and inorganic compounds, such as cadmium selenide core with a zinc sulfide coating (CdSe—ZnS), or copper indium sulfide (a.k.a. roquesite) with a zinc-sulfide shell (CuInS₂/ZnS) core-shell type QDs. In some implementations, other nanocrystal compounds may be used that exhibit appropriate quantum dot behavior, such as luminescence.

In one implementation, a dielectric layer(s) (e.g., first dielectric layer 408, second dielectric layer 402) may be constructed using silicon dioxide, silicon nitride(s), silicone(s), organo-silicates, acrylate based polymers, or any material providing sufficient dielectric properties for device operation. As an example, the dielectric layer (e.g., 406, 402) that is disposed in one of the top layers (e.g., second dielectric layer 402) may serve as a protective layer, or a protective layer may be incorporated on top of the dielectric layer. In one implementation, the protective layer can comprise properties that improve mechanical integrity and device operation characteristics, and protect the device from environmental conditions. Further, for example, additional properties of the protective layer may include hydrophobicity, oleophobicity, light filtering and cosmetic characteristics.

In one aspect, there are a variety of ways to construct a luminescent film 400, 500, as described herein. In this aspect, the various layers, including the emissive layer 404, can be laid using a variety of techniques. In one implementation, fabrication can comprise a solution coating technique, such as screen printing, slot-die coating, doctor blading, spin-coating, and/or spray coating. In another implementation, the film may be fabricated, at least in part, using various chemical vapor deposition techniques.

As illustrated in FIGS. 4 and 5, there are a variety of ways that a film 400, 500 used in a device can be constructed to achieve a desired result. For example, the device may be constructed with or without a dielectric layer on respective sides of the light emitting layer as shown in FIGS. 4 and 5. As one example 400, in FIG. 4, a first dielectric layer 406 is disposed under the light emitting layer 404 (e.g., emissive layer), and a second dielectric layer 402 is disposed over the light emitting layer 404. As another example 500, as illustrated in FIG. 5, a rear electrode (e.g., the first dielectric layer 406) can be omitted from the luminescent film 500. In one implementation, for example, as described above, the relief object contacting the surface may serve as the rear electrode, resulting in the light emitting layer to emit photons. In this implementation, when the device is used for fingerprint acquisition, the rear or top electrode (e.g., second dielectric layer 402) can be omitted.

The following table is merely one example implementation of such a film 400, 500, as illustrated in FIGS. 4 and 5, summarizing the layers that may be utilized, materials used for each layer, and thicknesses, as an example:

| Layers | Example Materials | Thickness | |
|---|---|---|---|
| Substrate | PET, Glass, | 10 microns-1.1 mm | |
| (e.g., 410) | Polyimide, etc. | | |
| Conductor | ITO, IZO, PEDOT, | .001-1 | micron |
| (e.g., 408) | etc. | | |
| Emissive | Ir(ppy)₃ and analogs, PVK, | 50-500 | angstroms |
| (e.g., 404) | PFO, F8BT, Quantum Dots: | | |
| | CdSe/ZnS, CuInS₂/ZnS | | |
| Dielectric | SiO₂, SiNx, organosiloxanes, | 0.1-4 | microns |
| (e.g., 408, | acralyates, acrylic polymers, | | |
| 402) | floropoymers, etc. | | |
| Protective | acralyates, acrylic polymers, | 0.1-10 | microns |
| (not shown) | floropoymers, etc. | | |

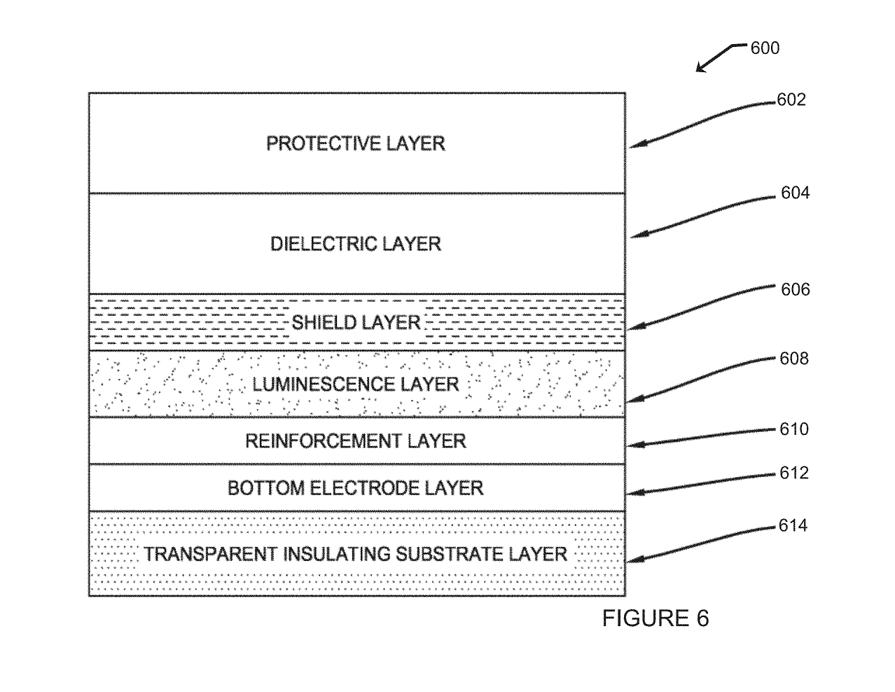

FIG. 6 is an example implementation of at least a portion of a film or layer 600, used as part of a system for scanning relief print images (e.g., biometric reader). In this implementation, the film 600 can comprise the luminescent layer 608. As one example, the luminescent layer 608 can comprise quantum dots to provide photons indicative of a relief object contacting the surface of the film 600. Further in this implementation, the film 600 can comprise a reinforcement layer 610 (e.g., a dielectric layer 406 of FIG. 4), the bottom electrode 612 (e.g., the conductor 408 of FIG. 4), and a substrate layer 614 (e.g., the substrate 410 of FIG. 4).

In one implementation, the film 600 can comprise a shield layer 606. The shield layer 606 can be a light shield that provides shielding pattern layers to direct incident light in a desired pattern toward the sensor array. That is, for example, the shield layer 606 can be configured to direct incident photons emitted by the luminescent layer 608 back down toward the bottom (e.g., toward the sensor array), and away from the top of the sensor film 600. Further, in this implementation, the film 600 can comprise a dielectric layer 604 (e.g., the second dielectric layer 402 of FIG. 4), and a protective layer 602 disposed over the dielectric layer 604. As an example, the protective layer 602 can comprise an abrasion resistive layer, a liquid resistive layer, and/or a shock resistive layer. In this example, the protective layer 602 can be used to mitigate damage (e.g., environmental and/or physical) to the film 600.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Reference throughout this specification to “one implementation” or “an implementation” means that a particular feature, structure, or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

What is claimed is:

1. A system for producing a relief print image, comprising:
a relief print data generation component to generate relief print data comprising an indication of light from a light emitting layer received by a sensor array, the relief print data generation component comprising:
the sensor array to convert received photons to an electrical signal indicative of the relief print data; and
the light emitting layer comprising quantum dots to provide electroluminescence, the light emitting layer operably disposed above the sensor array to emit photons from the quantum dots toward the sensor array, the photons indicative of one or more portions of a relief object disposed above the light emitting layer; and
an image generation component operably coupled with the relief print data generation component to convert the relief print data into image data indicative of a relief print image.

2. The system of claim 1, the quantum dots comprising one or more of:
core-type quantum dots;
core-shell quantum dots; and
alloyed quantum dots.

3. The system of claim 2:
the core-type quantum dots comprising one or more of: cadmium; zinc; indium; silicon;
germanium; cadmium sulfide (CdS); and cadmium selenide (CdSe); and
the core-shell quantum dots comprising one or more of: a cadmium selenide core with a zinc sulfide coating (CdSe—ZnS); and a copper indium sulfide core with a zinc-sulfide shell (CuInS₂/ZnS).

4. The system of claim 1, the sensor array comprising one or more of:
a photo-sensitive thin film transistor (TFT);
a thin film photo-diode;
a thin film photoconductor;
a complementary metal-oxide semiconductor (CMOS) image sensor; and
a charge-coupled device (CCD) image sensor.

5. The system of claim 1, the relief print data generation component comprising:
a plurality of sensor arrays, respective sensor arrays operably coupled to at least one other sensor array to convert received photons to an electrical signal; and
an image stitching component to stitch together relief print image data generated from respective sensor arrays, resulting in the relief print data indicative of the relief print image.

6. The system of claim 5, the relief print data generation component comprising a sensor array substrate adhered under respective sensor arrays.

7. The system of claim 1, wherein the light emitting layer comprises one or more of:
one or more polarizing layers;
one or more light shielding pattern layers to direct incident light in a desired pattern toward the sensor array; and
one or more adherence layers to respective layers.

8. The system of claim 1, the light emitting layer disposed over a substrate, and the substrate disposed over the sensor array.

9. The system of claim 1, the relief print data generation component comprises a protective layer disposed over light emitting layer, the protective layer comprising one or more of:
an abrasion resistive layer;
a liquid resistive layer; and
a shock resistive layer.

10. A biometric sensor device, comprising:
a luminescent layer comprising quantum dots to provide luminescence, the luminescent layer emitting photons upon contact from a biometric object; and
an image capture component disposed beneath the luminescent layer to convert at least a portion of the photons emitted into data indicative of an image comprising a representation of at least a portion of the biometric object.

11. The device of claim 10, the quantum dots comprising one or more of:
core-type quantum dots;
core-shell quantum dots; and
alloyed quantum dots.

12. The device of claim 11:
the core-type quantum dots comprising one or more of: cadmium; zinc; indium; silicon; germanium; cadmium sulfide (CdS); and cadmium selenide (CdSe); and
the core-shell quantum dots comprising one or more of: a cadmium selenide core with a zinc sulfide coating (CdSe—ZnS); and a copper indium sulfide core with a zinc-sulfide shell (CuInS₂/ZnS).

13. The device of claim 10, the luminescent layer disposed over at least a portion of a touch screen layer of a touch enabled device, and configured to emit photons toward the touch screen layer upon contact from the biometric object.

14. The system of claim 10, the luminescent layer comprising an electroluminescent layer comprising the quantum dots to emit the photons in response to an electrical charge received from the biometric object.

15. The system of claim 10, the luminescent layer comprising a dielectric layer disposed above the luminescent layer.

16. The system of claim 10, the luminescent layer comprising a shielding layer, disposed above the luminescent layer to mitigate emission of photons from a top surface of the luminescent layer.

17. The system of claim 10, comprising a protective layer disposed over the luminescent layer.

18. The system of claim 10, the image capture component communicatively coupled with an image processor to generate an image representing the biometric object from the data indicative of the image.

19. A method for manufacturing a system for producing a relief print image, comprising:
forming a relief print data generation component to generate relief print data from an indication of light emitted from electrically excited quantum dots in a light emitting layer to a sensor array, the forming comprising:
forming the light emitting layer comprising the quantum dots;
disposing the light emitting layer over the sensor array to convert the photons received from the quantum dots to an electrical signal, the light emitting layer operably disposed to emit the photons toward the sensor array that are indicative of one or more portions of a relief object disposed over the light emitting layer, the electrical signal comprising relief print data indicative of the one or more portions of a relief object; and
operably coupling an image generation component with the relief print data generation to generate relief print image data from the relief print data, the relief print image data indicative of an image of the one or more portions of a relief object.

20. The method of claim 19, forming the light emitting layer comprising using quantum dots comprising one or more or:
core-type quantum dots comprising one or more of: cadmium; zinc; indium; silicon;
germanium; cadmium sulfide (CdS); and cadmium selenide (CdSe);
core-shell quantum dots comprising one or more of: a cadmium selenide core with a zinc sulfide coating (CdSe—ZnS); and a copper indium sulfide core with a zinc-sulfide shell (CuInS₂/ZnS); and
alloyed quantum dots.
